(19) United States
(12) Patent Application Publication
(10) Pub. No.: US 2006/0055222 A1
(43) Pub. Date: Mar. 16, 2006

(54) Rotary recliner mechanism

(76) Inventors: Jeffery T. Bonk, Clinton Township, MI (US); Srinivas Pejathaya, St. Clair Shores, MI (US)

Correspondence Address: HARNESS, DICKEY & PIERCE, P.L.C., P.O. BOX 828, BLOOMFIELD HILLS, MI, 48303, US

(21) Appl. No.: 11/197,740

(22) Filed: Aug. 3, 2005

Related U.S. Application Data
(60) Provisional application No. 60/598,545, filed on Aug. 3, 2004.

(51) Int. Cl. B60N 2/235

(52) U.S. Cl. 297/367

(57) ABSTRACT

A recliner mechanism generally includes a housing, a back plate, and a locking mechanism. The back plate is rotatably supported in the housing. The locking mechanism selectively locks the back plate relative to the housing. The locking mechanism includes a cam, a pair of wedges, a pair of pawls and a plurality of slides. The wedges are displaced radially outward along a first axis by the cam. The pawls are displaced radially outward along a second axis to lockingly engage the housing in response to the cam displacing the wedges. The second axis is generally perpendicular to the first axis. The slides are disposed between the wedges and the pawls for transferring radial displacement of the wedges to the radial displacement of the pawls.

### CROSS-REFERENCE TO RELATED APPLICATIONS

This application claims the benefit of U.S. Provisional Application No. 60/598,545, filed on Aug. 3, 2004. The disclosure of the above application is incorporated herein by reference.

### FIELD

The present teachings generally relate to a vehicle seat recliner and, more particularly, to a rotary recliner mechanism for a vehicle seat.

### BACKGROUND

Rotary recliner mechanisms generally include of a first rotary member having a plurality of teeth and a second rotary member having a plurality of teeth adapted to lockingly engage the teeth to couple the rotary members to one another. Typically, one rotary member is mounted to a quadrant for attachment to a seatback and the second rotary member is mounted to a base plate for attachment to a seat base. The rotary recliner mechanisms are operable to lock the rotary member connected to the seatback, thereby restricting its rotation.

The rotary recliner mechanism is selectively locked by manipulating one of the rotary members between an engaged position, wherein the first and second rotary members meshingly engage, and a disengaged position where one of the rotary members retracts from engagement with the other. Locking rotary recliner mechanisms also may include a device, such as a spring, for releasably urging one of the rotary members into the engaged position so that the default position for the mechanism is a locked condition. Further, the rotary recliner typically includes an activating mechanism that moves one of the mechanisms between the above-described engaged and disengaged positions.

In reclining seats, the seatback functions as an extremely long lever arm. The locking rotary recliner mechanism is relatively small compared to the length of the reclining seatback. Vehicle vibration or movement of an occupant may impose various forces upon the seatback lever during use. These forces impose large moments on the rotary members engaging to lock the rotary recliner mechanism. If the forces are sufficient, or the rotary recliner mechanism is poorly designed, these forces can overcome the capability of the rotary recliner mechanism to anchor the seatback.

### SUMMARY

A recliner mechanism according to the teachings may include a housing, a back plate, and a locking mechanism. The back plate is rotatably supported in the housing and is selectively locked thereto by the locking mechanism. The locking mechanism may include a cam, a pair of wedges, a pair of pawls, and a plurality of slides. The wedges are displaced radially outward along a first axis by the cam. The pawls are displaced radially outward along a second axis to lockingly engage the housing in response to the cam displacing the wedges, whereby the second axis is generally perpendicular to the first axis. The slides are disposed between the wedges and the pawls for transferring radial displacement of the wedges to the radial displacement of the pawls.

Further areas of applicability of the present teachings will become apparent from the detailed description provided hereinafter. It should be understood that the detailed description and specific examples are not intended to limit the scope of the teachings.

### BRIEF DESCRIPTION OF THE DRAWINGS

The present teachings will become more fully understood from the detailed description and the accompanying drawings, wherein:

FIG. 1 is a side view of a vehicle seat assembly including a recliner mechanism in accordance with the principles of the present teachings;

FIG. 2 is an exploded perspective view of the recliner mechanism of FIG. 1;

FIG. 3 is a perspective view of a recliner mechanism in accordance with the principles of the present teachings in an engaged position with a cover plate removed to expose a release cam;

FIG. 4 is a perspective view of the recliner mechanism of FIG. 3 in a disengaged position;

FIGS. 5A and 5B are side views of the recliner mechanism of FIG. 3 in the engaged position with a release cam removed; and

FIGS. 6A and 6B are side views of the recliner mechanism of FIG. 5 in the disengaged position.

### DETAILED DESCRIPTION

The following description is merely exemplary in nature and is in no way intended to limit the teachings, its applications, or uses.

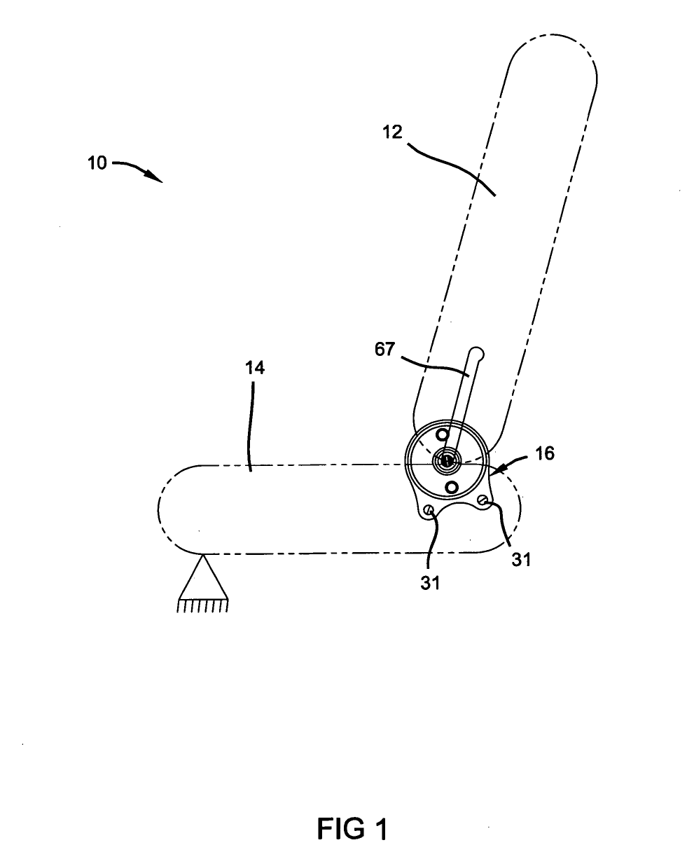

FIG. 1 depicts a vehicle seat assembly 10 generally including a seatback 12, a seat bottom 14, and a recliner mechanism 16. The seatback 12 is pivotally supported on the seat bottom 14 and may be locked in any one of a plurality of positions relative to the seat bottom 14 by the locking mechanism 16.

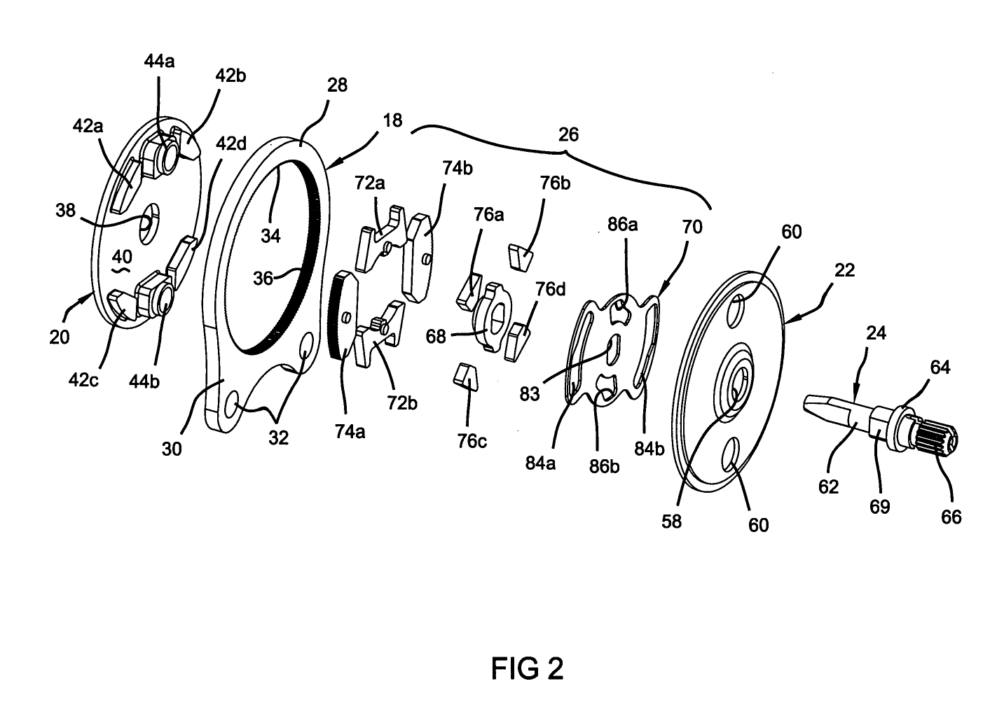

FIGS. 2-6 depict the recliner mechanism 16 including a housing plate 18, a back plate 20, a cover plate 22, a pivot pin 24, and a locking mechanism 26. The housing plate 18 includes a housing portion 28 and a flange portion 30. The flange portion 30 includes a pair of fastener bores 32 adapted to receive a pair of fasteners 31 and fit the recliner mechanism 16 to the seat bottom 14. The housing portion 28 includes a central aperture 34 defining a plurality of internal teeth 36.

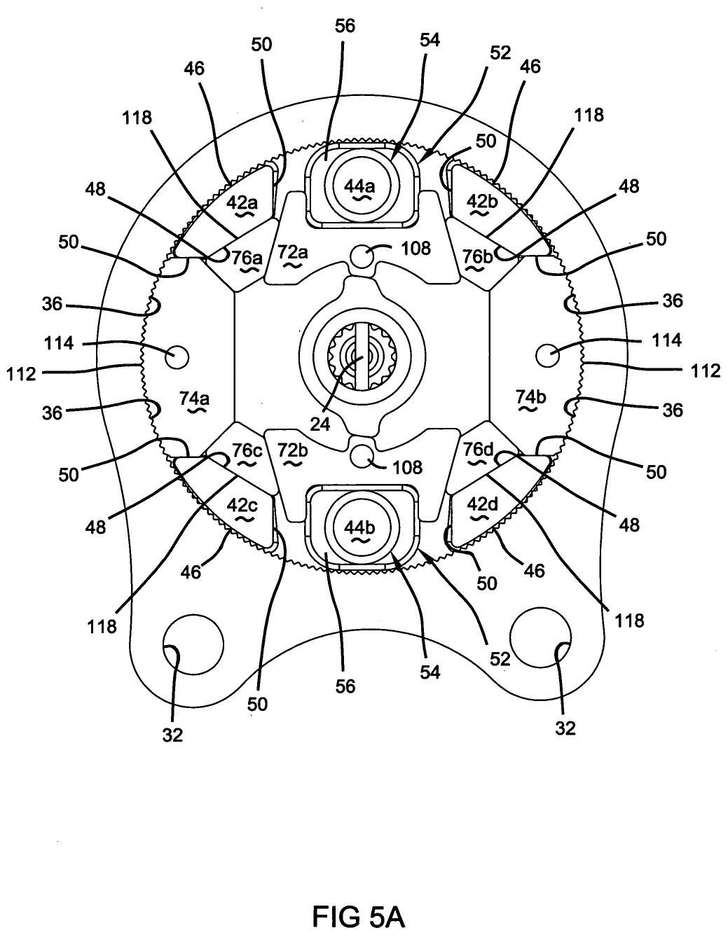

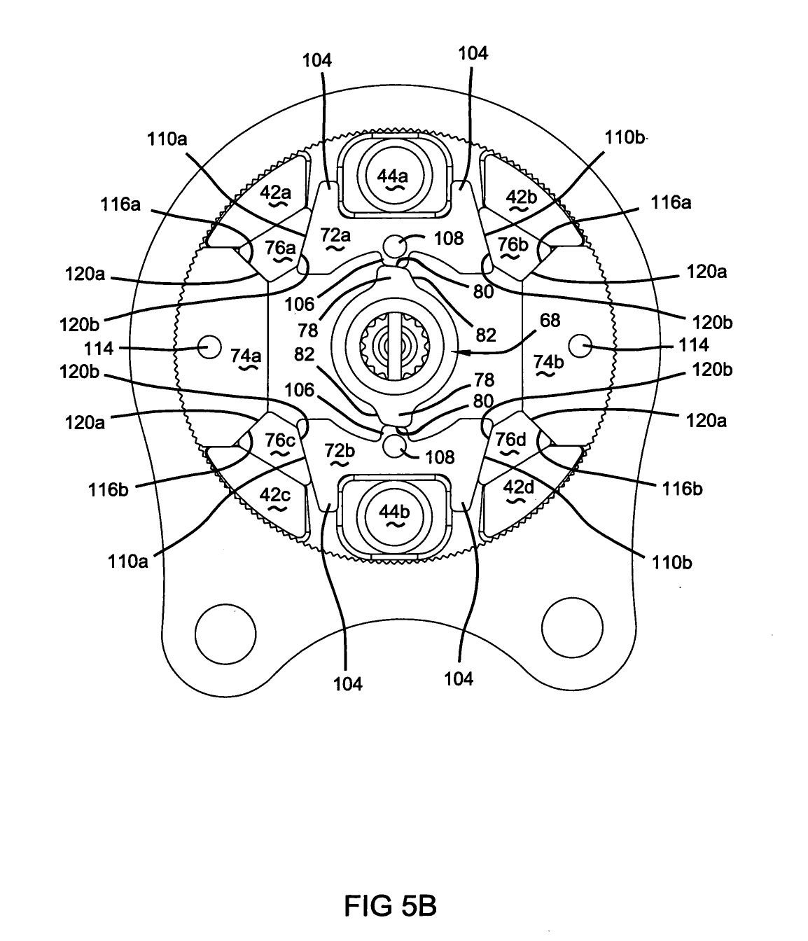

The back plate 20 includes a pivot aperture 38 and an inner surface 40. The inner surface 40 defines a plurality of slide bosses 42 and a pair of guide bosses 44. The plurality of slide bosses 42 includes a first slide boss 42a, a second slide boss 42b, a third slide boss 42c, and a fourth slide boss 42d. As best illustrated in FIGS. 5A and 5B, each slide boss 42 includes a semi-circumferential surface 46, a sliding surface 48, and a pair of radial surfaces 50. The pair of radial surfaces 50 extend between the semi-circumferential surfaces 46 and sliding surfaces 48. The pair of guide bosses 44 include a first guide boss 44a and a second guide boss 44b, each including a body portion 52 and a post portion 54. The body portion 52 includes a shoulder surface 56. The post portion 54 is generally cylindrical and extends axially away from the shoulder surface 56 of the body portion 52.

The cover plate 22 includes generally cylindrical plates having a central aperture 58 and a pair of post apertures 60. As shown in FIGS. 2, 5A, and 6A, the pair of post apertures 60 receive the post portions 54 of the guide bosses 44 to maintain the rotational disposition of the cover plate 22 relative to the back plate 20.

The pivot pin 24 includes a tenon portion 62, a shoulder portion 64, and a toothed portion 66. The tenon portion 62 includes a pair of diametrically opposed flat surfaces 69. The pivot pin 24 extends through the central aperture 58 of the cover plate 22 and the pivot aperture 38 of the back plate 20. The shoulder portion 64 abuts the cover plate 22 to maintain the axial disposition of the pivot pin 24. As shown in FIG. 1, the toothed portion 66 is adapted to be engaged by an actuation lever 67.

The locking mechanism 26 includes a locking cam 68, a release cam 70, a pair of wedges 72, a pair of pawls 74, and a plurality of slides 76. The locking mechanism 26 may be moved between an engaged position that selectively prevents relative rotation of the back plate 20, cover plate 22, and pivot pin 24 relative to the housing plate 18 and a disengaged position that permits relative rotation of the back plate 20, cover plate 22, and pivot pin 24 relative to the housing plate 18.

The locking cam 68 is a generally annular member defining a pair of radial arms 78. The radial arms 78 each include a locking surface 80 and a thrust surface 82. As illustrated in FIGS. 2, 3 and 4, the release cam 70 is a generally planar member defining a central aperture 83, a pair of major peanut slots 84, and a pair of minor peanut slots 86. The pair of major peanut slots 84 includes a first major peanut slot 84a and a second major peanut slot 84b. The major peanut slots 84 each include an inner edge 88, an outer edge 90, and opposing radial edges 92. The outer edges 90 include a radially converging portion 94. The pair of minor peanut slots 86 includes a first minor peanut slot 86a and a second minor peanut slot 86b. The minor peanut slots 86 each include an inner edge 96, an outer edge 98, and opposing radial edges 100. The outer edge 98 includes a radially converging portion 102. The minor peanut slots 86 are generally smaller than the major peanut slots 84.

As illustrated in FIGS. 2, 5 and 6, the pair of wedges 72 includes a first wedge 72a and a second wedge 72b, each acting as a transfer element to transfer a force from the locking cam 68 to the pawls 74a, 74b. The wedges 72 each include a pair of radial arms 104, a radial boss 106, an axial boss 108, a first driving surface 110a, and a second driving surface 110b. The pair of pawls 74 includes a first pawl 74a and a second pawl 74b. The pawls 74 each include a toothed semi-circular surface 112, an axial boss 114, a first driven surface 116a, and a second driven surface 116b. The plurality of slides 76 includes a first slide 76a, a second slide 76b, a third slide 76c, and a fourth slide 76d. The slides 76a, 76b, 76c, 76d each act as a transfer element to transfer a force from the wedges 72a, 72b to the pawls 74a, 74b. Each slide includes a sliding surface 118, a first radially converging surface 120a, and a second radially converging surface 120b.

In operation, when the locking cam 68 is rotated into the engaged position, the wedges 72a, 72b are caused to axially move toward an outer perimeter of the housing plate 18. As the wedges 72a, 72b move, the slides 76a, 76b, 76c, and 76d are compressed between the wedges 72a, 72b and the pawls 74a, 74b, respectively, thereby concurrently causing the pawls 74a, 74b to axially move toward the outer perimeter of the housing plate 18. Once the pawls 74a, 74b have sufficiently moved toward an outer perimeter of the housing plate 18, the teeth 112 of each pawl 74a, 74b engage the teeth 36 of the housing plate 18 to prevent rotation of the housing plate 18.

In the engaged position, the locking cam 68, wedges 72a, 72b, and slides 76a, 76b, 76c, 76d are subjected to compressive loading. Placing the locking cam 68, wedges, 72a, 72b, and slides 76a, 76b, 76c, 76d under compression allows each of the locking cam 68, wedges, 72a, 72b, and slides 76a, 76b, 76c, 76d to be formed from a less-ductile material as each of the locking cam 68, wedges, 72a, 72b, and slides 76a, 76b, 76c, 76d experiences only a minimal a shear load.

For example, each of the locking cam 68, wedges, 72a, 72b, and slides 76a, 76b, 76c, 76d may formed from powder metal. Forming the locking cam 68, wedges, 72a, 72b, and slides 76a, 76b, 76c, 76d from a powder metal allows a reduction in manufacturing tooling complexity and cost and therefore reduces the component part cost. While powder metal is disclosed, it should be understood that the locking cam 68, wedges, 72a, 72b, and slides 76a, 76b, 76c, 76d may be formed from any suitable manufacturing process, such as, but not limited to, fine blanking and the like.

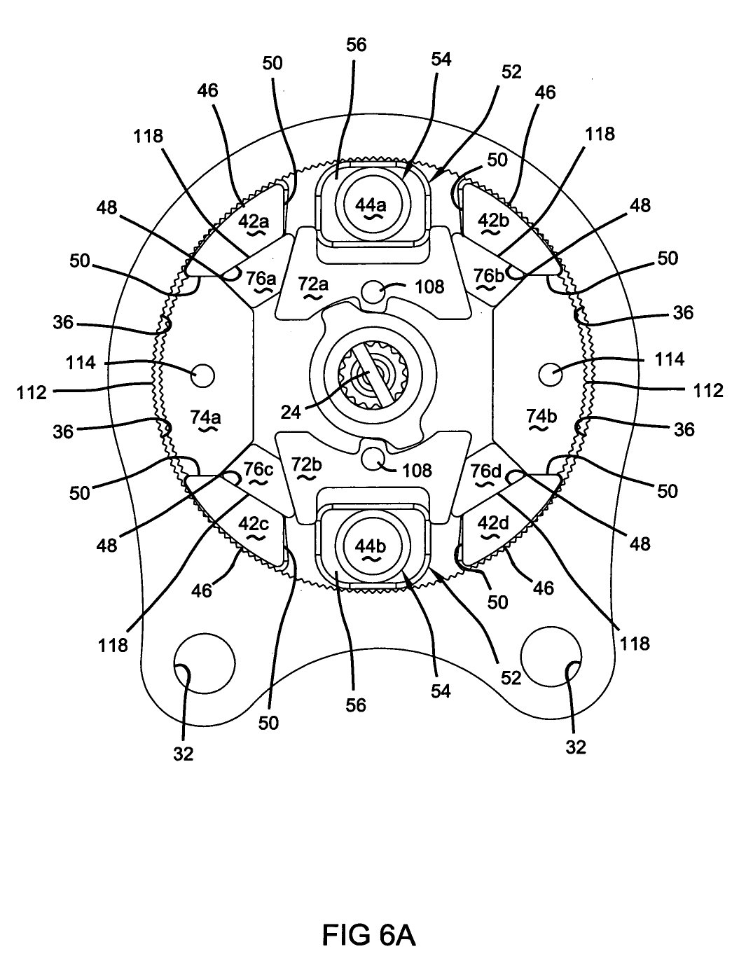

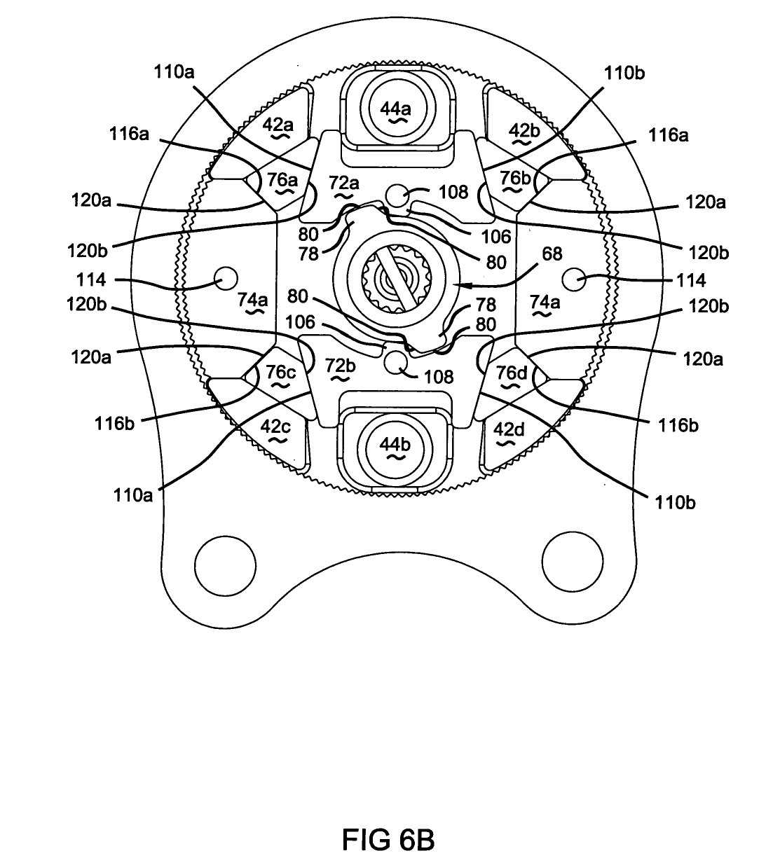

FIGS. 5 and 6 depict the recliner mechanism 16 assembled with the cover plate 22 and release cam 70 removed to expose the locking mechanism 26. It should be understood that for the purposes of clarity, FIGS. 5A and 5B are duplicates of each other except for the reference numerals provided therein. Likewise, FIGS. 6A and 6B are duplicates of each other except for the reference numerals provided therein.

The locking cam 68 is disposed on the pivot pin 24. The first wedge 72a is slidably disposed on the inner surface 40 of the back plate 20 generally between the locking cam 68 and the first guide boss 44a. The second wedge 72b is slidably disposed on the inner surface 40 of the back plate 20 generally between the locking cam 68 and the second guide boss 44b.

The first slide 76a is slidably disposed on the inner surface 40 of the back plate 20 generally adjacent to the first slide boss 42a. The second radially converging surface 120b of the first slide 76a slidably engages the first driving surface 110a of the first wedge 72a. The sliding surface 118 of the first slide 76a slidably engages the sliding surface 48 of the first slide boss 42a. The second slide 76b is disposed on the inner surface 40 of the back plate 20 generally adjacent to the second slide boss 42b. The second radially converging surface 120b of the second slide 76b slidably engages the second driving surface 110b of the first wedge 72a. The sliding surface 118 of the second slide 76b slidably engages the sliding surface 48 of the second slide boss 42b. The third slide 76c is disposed on the inner surface 40 of the back plate 20 generally adjacent to the third slide boss 42c. The second radially converging surface 120b of the third slide 76c slidably engages the first driving surface 110a of the second wedge 72b. The sliding surface 118 of the third slide 76c slidably engages the sliding surface 48 of the third slide boss 42c. The fourth slide 76d is disposed on the inner surface 40 of the back plate 20 generally adjacent to the fourth slide boss 42d. The second radially converging surface 120b of the fourth slide 76d slidably engages the second driving surface 110b of the second wedge 72b. The sliding surface 118 of the fourth slide 76d slidably engages the sliding surface 48 of the fourth slide boss 42d.

The first pawl 74a is disposed on the inner surface 40 of the back plate 20 generally between the first and third slide bosses 42a, 42c. The first driven surface 116a of the first pawl 74a slidably engages the first radially converging surface 120a of the first slide 76a. The second driven surface 116b of the first pawl 74a slidably engages the first radially converging surface 120a of the third slide 76c. The second pawl 74b is disposed on the inner surface 40 of the back plate 20 generally between the second and fourth slide bosses 42b, 42d. The first driven surface 116a of the second pawl 74b slidably engages the first radially converging surface 120a of the second slide 76b. The second driven surface 116b of the second pawl 74b slidably engages the first radially converging surface 120a of the fourth slide 76d.

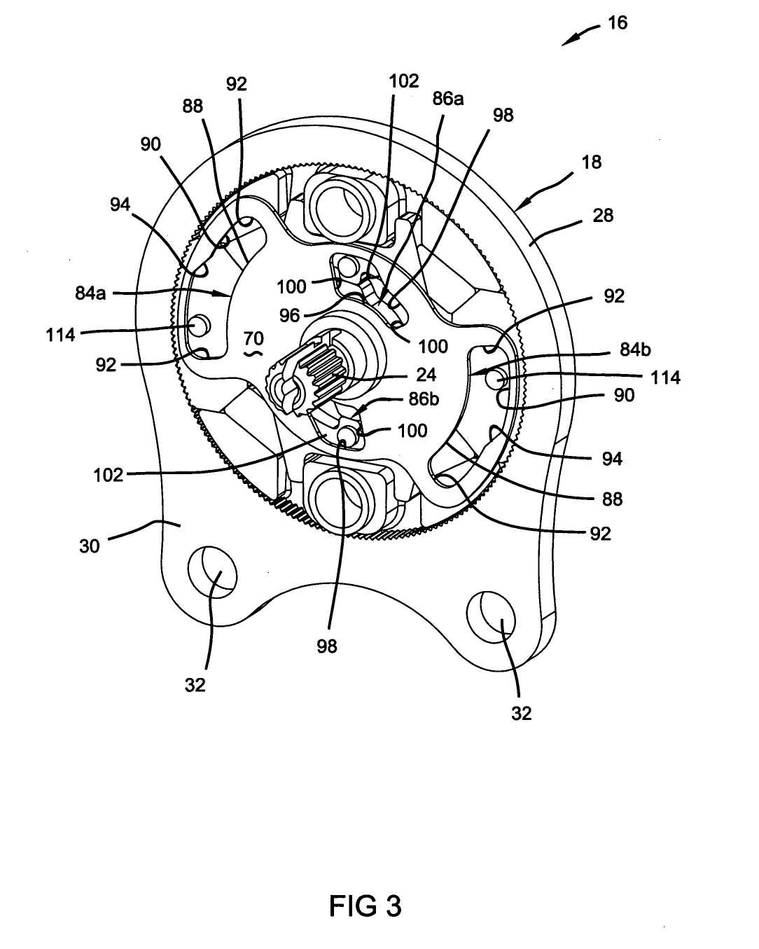

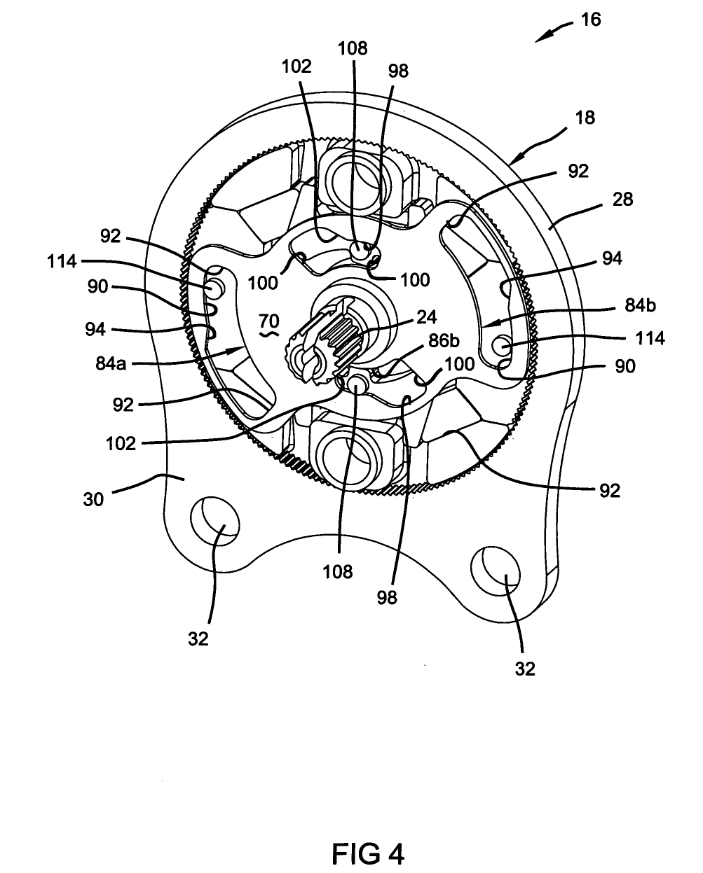

As best seen in FIGS. 3 and 4, locking cam 68 and the central aperture 83 of release cam 70 matingly receive tenon portion 62 of the pivot pin 24 such that the locking cam 68 and release cam 70 are fixed for rotation with the pivot pin 24. The first major peanut slot 84 receives the axial boss 114 of the first pawl 74a. The second major peanut slot 84b receives the axial boss of the second pawl 74b. The first minor peanut slot 86a receives the axial boss 108 of the first wedge 72a. The second minor peanut slot 86b receives the axial boss 108 of the second wedge 72b.

FIGS. 3 and 5 depict the recliner mechanism 16 having the locking mechanism 26 in the engaged position. The axial bosses 108 of the pair of wedges 72 are disposed in the minor peanut slots 86 at a location displaced counterclockwise from the radially converging portion 102 of the outer edge 98. The axial bosses 114 of the pair of pawls 74 are disposed within the major peanut slots 84 at a location displaced counterclockwise from the radially converging portions 94 of the outer edge 90. The wedges 72 engage the guide bosses 44 such that radial arms 104 receive the body portions 52. The toothed semi-circular surfaces 112 of the pawls 74 meshingly engage the internal teeth 36 of the central aperture 34 of the housing plate 18.

To disengage the recliner mechanism 16, the lever 67 (shown in FIG. 1) is pivoted in a counterclockwise direction relative to the housing plate 18. This pivots the locking cam 68 counterclockwise such that the locking surfaces 80 of the radial arms 78 disengage the radial bosses 106 on the pair of wedges 72. The release cam 70 also pivots counterclockwise. The radially converging portions 94 of the outer edges 90 of the pair of major peanut slots 84 engage the axial bosses 114 on the pair of pawls 74. The radially converging portions 102 of the outer edges 98 of the minor peanut slots 86 engage the axial bosses 108 on the pair of wedges 72. Such engagement causes inward radial displacement of the pair of wedges 72 and the pair of pawls 74 to the position illustrated in FIG. 5, thereby disengaging the recliner mechanism 16.

To re-engage the recliner mechanism 16, the lever 67 (shown in FIG. 1) is pivoted in a clockwise direction relative to the housing plate 18. This pivots the locking cam 68 clockwise such that the thrust surfaces 82 of the radial arms 78 slidingly engage the radial bosses 106 on the pair of wedges 72. The wedges 72 are moved along a linear axis according to guide bosses 44 and displaced radially outward relative to the locking cam 68 until the locking surfaces 80 reach the radial bosses 106. The first driving surface 110a of the first wedge 72a slidably engages and drives the second radially converging surface 120b of the first slide 76a. The first radially converging surface 120a of the first slide 76a slidably engages and drives the first driven surface 116a of the first pawl 74a. The first driving surface 110a of the second wedge 72b slidably engages and drives the second radially converging surface 120b of the third slide 76c. The first radially converging surface 120a of the third slide 76c slidably engages and drives the second driven surface 116b of the first pawl 74a. This displaces the first pawl 74a radially outward such that the toothed semi-circular surface 112 lockingly engages the plurality of internal teeth 36 on in the central aperture 34 of the housing plate 18.

Concurrently, the second driving surface 110b of the first wedge 72a slidably engages and drives the second radially converging surface 120b of the second slide 76b. The first radially converging surface 120a of the second slide 76b slidably engages the first driven surface 116a of the second pawl 74b. The second driving surface 110b of the second wedge 72b slidably engages the second radially converging surface 120b of the fourth slide 76d. The first radially converging surface 120a of the fourth slide 76d slidably engages the second driven surface 11 6b of the second pawl 74b. This displaces the second pawl 74a radially outward such that the toothed semi-circular surface 112 lockingly engages the plurality of internal teeth 36 on in the central aperture 34 of the housing plate 18.

The normal forces produced at the driving surfaces 110, the driven surfaces 116, and the radially converging surfaces 120 place each of the locking cam 68, wedges 72a, 72b, and slides 76a, 76b, 76c, 76d under compression when in the engaged position. Thus, the locking cam 68, wedges 72a, 72b, and slides 76a, 76b, 76c, 76d are only subjected to a minimal shear force and may be formed from a relatively ductile material, such as powder metal. As previously discussed, use of a powder metal process reduces manufacturing cost and complexity and therefore reduces component cost.

When in the engaged position, the forces applied to the pawls 74a, 74b are applied generally perpendicular to the force applied by the locking cam 68 to the wedges 72a, 72b. When assembled to a vehicle seat 10, the recliner mechanism 16 is positioned such that movement of the wedges 72a, 72b is generally along a first axis that is parallel to the vehicle seatback 12. When the locking mechanism 26 is in the engaged position, the pawls 74a, 74b are extended into engagement with the teeth 36 of the housing plate 18 along a second axis that is generally perpendicular to the first axis.

When the vehicle seat 10 is in use, a force applied to the seatback 12 is applied generally along the second axis and is transmitted by the seatback 12 to the recliner mechanism 16. If the locking mechanism 26 is in the engaged position, the pawls 74a, 74b are in contact with the teeth 36 of the housing plate 18 along the second axis and resist rotation of the seatback 12 relative to the seat bottom 14. By causing the pawls 74a, 74b to engage the housing plate 18 such that the point of contact between the pawls 74a, 74b and the housing plate 18 is generally along the second axis, tight engagement between the pawls 74a, 74b and the housing plate 18 is improved when a force is applied to the seatback 12 along the second axis.

Engagement is improved as at least one of the pawls 74a, 74b is caused to be in closer proximity to the housing plate 18. Causing the pawls 74a, 74b to be in closer proximity to the housing plate 18 improves the ability of the recliner mechanism 16 to prevent rotation of the seatback 12 relative to the seat bottom 14.

The description is merely exemplary in nature and, thus, variations are not to be regarded as a departure from the spirit and scope of the teachings.

What is claimed is:

1. A seat adjustment mechanism comprising:
a first housing plate;
a second housing plate rotatable relative to said first housing plate and including a first plurality of teeth;
a cam operably supported by one of said first and second housing plates and rotatable between a locked position and an unlocked position;
at least one transfer element receiving a force from said cam in said locked position, said force applied to said at least one transfer element along a first axis; and
at least one pawl having a second plurality of teeth, said at least one pawl receiving a force from said at least one transfer element along a second axis when said cam is in said locked position to urge said second plurality of teeth into engagement with said first plurality of teeth to prevent rotation of said second housing plate relative to said first housing plate, wherein said first axis is generally perpendicular to said second axis.

2. The seat adjustment mechanism of claim 1, wherein said at least one transfer element includes at least one wedge moveable along said first axis in response to movement of said cam between said locked position and said unlocked position.

3. The seat adjustment mechanism of claim 2, wherein said at least one transfer element includes at least one slide in slidable engagement with said at least one wedge.

4. The seat adjustment mechanism of claim 3, wherein said at least one slide includes a first engagement surface and a second engagement surface, said first engagement surface receiving a force from said at least one wedge along said first axis when said cam is in said locked position and said second engagement surface applying said force to said at least one pawl along said second axis.

5. The seat adjustment mechanism of claim 3, wherein said first housing plate includes at least one slide boss in selective engagement with said at least one slide.

6. The seat adjustment mechanism of claim 5, wherein said slide boss is fixed relative to said first housing plate to urge said at least one slide into engagement with said at least one wedge and said at least one pawl when said cam is in said locked position.

7. A recliner mechanism, comprising:
a first housing plate;
a second housing plate rotatable relative to said first housing plate and including a first plurality of teeth;
a cam operably supported by one of said first and second housing plates and rotatable between a locked position and an unlocked position;
a first transfer element receiving a force from said cam to place said first transfer element under compression when said cam is in said locked position;
a second transfer element receiving a force from said first transfer element to place said second transfer element under compression when said cam is in said locked position; and
at least one pawl having a second plurality of teeth, said at least one pawl receiving a force from said second transfer element when said cam is in said locked position to urge said second plurality of teeth into engagement with said first plurality of teeth to prevent rotation of said second housing plate relative to said first housing plate.

8. The recliner mechanism of claim 7, further comprising a release cam operable to rotate said cam between said locked position and said unlocked position.

9. The recliner mechanism of claim 8, wherein said release cam includes at least one major cam slot in slideable engagement with said at least one wedge to move said at least one wedge between said first position and said second position.

10. The recliner mechanism of claim 8, wherein said release cam includes at least one minor cam slot in slideable engagement with said at least one pawl to move said at least one pawl into engagement with said first plurality of teeth.

11. The recliner mechanism of claim 7, wherein said first plurality of teeth are in engagement with said second plurality of teeth along a first axis and said locking cam is in engagement with said first transfer element along a second axis complementary to said first axis.

12. The seat adjustment mechanism of claim 11, wherein said second transfer element includes a first engagement surface and a second engagement surface, said first engagement surface receiving a force from said first transfer element along said first axis when said cam is in said locked position and said second engagement surface applying said force to said at least one pawl along said second axis.

13. The recliner mechanism of claim 7, wherein said back plate includes at least one slide boss in selective engagement with at least one of said first transfer element and said second transfer element.

14. The recliner mechanism of claim 13, wherein said slide boss is fixed relative to said first housing plate to urge said first transfer element into engagement with said second transfer element and said at least one pawl when said cam is in said locked position.

15. The seat adjustment mechanism of claim 7, further comprising at least two first transfer elements.

16. The seat adjustment mechanism of claim 7, further comprising at least two second transfer elements.

17. A seat assembly comprising:
a seat bottom;
a seat back rotatably supported by said seat bottom; and
a recliner mechanism disposed between said seat bottom and said seat back, said recliner mechanism is selectively preventing rotation of said seatback relative to said seat bottom and including:
a first housing plate;
a second housing plate rotatable relative to said first housing plate and including a first plurality of teeth;
a cam operably supported by one of said first and second housing plates and rotatable between a locked position and an unlocked position;
at least one transfer element receiving a force from said cam in said locked position, said force applied to said at least one transfer element along a first axis; and
at least one pawl having a second plurality of teeth, said at least one pawl receiving a force from said at least one transfer element along a second axis when said cam is in said locked position to urge said second plurality of teeth into engagement with said first plurality of teeth to prevent rotation of said second housing plate relative to said first housing plate, wherein said first axis is generally perpendicular to said second axis;
wherein said at least one transfer element includes at least one wedge moveable along said first axis in response to movement of said cam between said locked position and said unlocked position;
wherein said first plurality of teeth are formed on an inner circumferential surface of said first housing plate.

18. The seat assembly mechanism of claim 17, wherein said at least one transfer element includes at least one wedge moveable along said first axis in response to movement of said cam between said locked position and said unlocked position.

19. The seat adjustment mechanism of claim 18, wherein said at least one transfer element includes at least one slide in slidable engagement with said at least one wedge.

20. The seat adjustment mechanism of claim 19, wherein said at least one slide includes a first engagement surface and a second engagement surface, said first engagement surface receiving a force from said wedge along said first axis when said cam is in said locked position and said second engagement surface applying said force to said at least one pawl along said second axis.

21. The seat adjustment mechanism of claim 19, wherein said first housing plate includes at least one slide boss in selective engagement with said at least one slide.

22. The seat adjustment mechanism of claim 21, wherein said slide boss is fixed relative to said first housing plate to urge said at least one slide into engagement with said at least one wedge and said at least one pawl when said cam is in said locked position.
